(19) United States
(12) Patent Application Publication
(10) Pub. No.: US 2006/0010867 A1
(43) Pub. Date: Jan. 19, 2006

(54) Individual cogeneration plant

(76) Inventor: Peter Alexander Shaw, Charlotte, NC (US)

Correspondence Address: Adams Evans P.A., 2180 Two Wachovia Center, 301 S. Tryon Street, Charlotte, NC, 28282, US

(21) Appl. No.: 10/894,272

(22) Filed: Jul. 19, 2004

(51) Int. Cl. B60K 16/00; B60L 8/00; F03G 6/00

(52) U.S. Cl. 60/641.8

(57) ABSTRACT

An individual cogeneration plant includes a collector for collecting solar energy and transmitting heat generated from the solar energy, and a boiler in communication with the collector for generating steam from water using the heat transmitted from the collector. A generator communicates with the boiler for generating electricity from the steam generated by the boiler, and unused electricity generated by the system can be stored as hydrogen gas for future use, or transferred to an external main power grid. A control unit can be programmed to make determinations regarding an optimum setting for operation based on current conditions. Multiple cogeneration plants can be interconnected with each other and the main power grid. The individual cogeneration plants can provide power to each other and the main power grid based on current user demands.

### TECHNICAL FIELD AND BACKGROUND INVENTION

The invention relates to an individual cogeneration plant that can provide power to an individual structure, such as a residence, using an independent energy source, or when the independent energy source is not available, by other energy sources such as stored hydrogen gas or natural gas. In addition, the individual cogeneration plant can store unneeded energy for future use, or transfer it to a main power grid. The invention includes a control unit for determining whether the cogeneration plant generates energy using the independent energy source or imports energy from an external source, and whether unneeded energy is stored or transferred. The control units makes such determinations based on several factors such as the availability of the independent energy source, the cost of external energy sources, and the price paid for energy transferred out of the cogeneration plant.

In an effort to reduce pollution and conserve finite energy sources like petroleum and natural gas, and in response to the steadily rising cost of such energy sources, a number of prior art inventions have been made for utilizing solar energy to provide power to a residence or other structure. For example, U.S. Pat. No. 4,026,267 to Coleman discloses a solar energy apparatus for gathering and transmitting solar radiation to an energy storage area. The apparatus includes a wide-angle lens to focus solar energy on an end of an optical fiber bundle. U.S. Pat. No. 5,501,743 to Cherney discloses a fiber optical solar power generating system having a tower outside a structure to be supplied with solar energy, and a plurality of collectors.

The above prior art inventions disclose devices for utilizing solar energy to provide power to a structure, however, there are times when atmospheric conditions deny a sufficient supply of solar energy. In such a situation, the structure must be powered by another energy source, or be deprived of power altogether. As such, it is generally desirable for a solar energy apparatus to be alternatively powerable by other energy sources such as natural gas or stored hydrogen gas, or to allow the structure to be powered by electricity from a main power grid. Furthermore, as conditions change, such as atmospheric conditions and economic conditions relating to the supply and demand of various power sources, the economic desirability of operating using solar energy rather than another energy source, fluctuates as well. It would therefore be desirable to determine the optimal energy source for an energy producing apparatus based on such varying factors and to run the energy producing apparatus accordingly.

### SUMMARY OF THE INVENTION

Therefore, it is an object of the present invention to provide a system that can produce energy for a structure using a renewable energy source such as solar energy, and can be alternatively powered using another energy source such as natural gas or hydrogen gas stored in the system, or electricity provided by an external main power grid.

Another object of the present invention is to provide a system that can provide power to an individual structure using a renewable energy source such as solar energy, and can store unneeded power in the form of hydrogen gas, or transfer the unneeded power to an external main power grid.

These and other objectives of the present invention are achieved by providing a system for providing power having a collector for collecting solar energy and transmitting heat generated from the solar energy, and a boiler in communication with the collector and having water for generating steam from the heat transmitted from the collector. A generator communicates with the boiler for generating electricity from the steam generated by the boiler, and unused electricity generated by the system can be transformed into storable energy for future use. As such, unused electricity can be stored in the system or transferred out of the system.

According to a preferred embodiment of the invention, the unused electricity transferred out of the system is transferred to a main power grid.

According to another preferred embodiment of the invention, the collector includes a solar dish and a focuser for collecting the solar energy.

According to yet another preferred embodiment of the invention, the collector includes a fiber optic cable for transmitting the heat generated by the solar energy.

According to yet another preferred embodiment of the invention, the collector includes a plurality of mirrors for transmitting the heat generated by the solar energy.

According to yet another preferred embodiment of the invention, the collector includes a fresnel lens for collecting the solar energy.

According to yet another preferred embodiment of the invention, the collector includes a fiber optic cable for transmitting the heat generated by the solar energy.

According to yet another preferred embodiment of the invention, the collector includes a plurality of mirrors for transmitting the heat generated by the solar energy.

According to yet another preferred embodiment of the invention, the boiler is connected to the collector and adapted for receiving heat transmitted by the collector.

According to yet another preferred embodiment of the invention, the boiler includes burners for receiving heat to convert the water to steam.

According to yet another preferred embodiment of the invention, the generator includes a steam turbine and an electrical generator, the steam turbine drives the electrical generator.

According to yet another preferred embodiment of the invention, the unused electricity stored in the system is stored as hydrogen gas.

According to yet another preferred embodiment of the invention, the system generates hydrogen gas from water, and unused electricity powers the generation of the hydrogen gas from water and the hydrogen gas is stored for future use as energy.

According to yet another preferred embodiment of the invention, the system includes a control unit so that a user can control whether unused electricity is stored in the system or transferred out of the system.

According to yet another preferred embodiment of the invention, the system includes a positioning device for positioning the collector in a position suitable for receiving solar energy.

According to yet another preferred embodiment of the invention, the system supplies power to a structure, and the system is connected to a power grid supplying power to a plurality of structures. Power transferred out of the system can be transferred to the power grid.

According to yet another preferred embodiment of the invention, the system is connected to a natural gas source, so that natural gas can be supplied to the system when solar energy is unavailable.

According to yet another preferred embodiment of the invention, the natural gas source is connected to the boiler for providing an alternative energy source to the boiler when solar energy is unavailable.

According to yet another preferred embodiment of the invention, the system is powerable by solar energy, stored hydrogen gas, natural gas and electricity provided by an external power grid.

According to yet another preferred embodiment of the invention, a control unit selects the energy source for powering the structure based on one or more predetermined factors, such as atmospheric conditions, cost of the electricity from the external power grid, cost of the natural gas, price paid for power transferred to the external power grid, and price paid for the stored hydrogen gas.

According to yet another preferred embodiment of the invention, the control unit determines whether unused electricity will be stored as hydrogen gas or transferred out of the system based on one or more predetermined factors, such as atmospheric conditions, cost of the electricity from the external power grid, cost of the natural gas, price paid for power transferred to the external power grid, and price paid for the stored hydrogen gas.

According to yet another preferred embodiment of the invention, the system includes a collector for collecting energy from an energy source, and a generator for generating electricity from the energy collected by the collector. Unused electricity is transformed into storable energy for future use, and the system is connected to an external power grid and power is transferable between the system and the power grid so that unused electricity can be stored in the system for future use or transferred to the power grid.

According to yet another preferred embodiment of the invention, a system for providing power includes an individual cogeneration plant adapted for providing power to a structure using an independent energy source. The cogeneration plant is in communication with an external power grid in communication with the structure so that power can be supplied to the structure by the individual cogeneration plant and the external power grid. A control unit communicates with the individual cogeneration plant for determining an optimal setting for the individual cogeneration plant based on one or more predetermined factors such as atmospheric conditions, cost of the electricity from the external power grid, cost of the natural gas, price paid for power transferred to the power grid, and price paid for stored hydrogen gas.

According to yet another preferred embodiment of the invention, the control unit determines whether the individual cogeneration plant is powered by the independent energy source or by the power grid.

According to yet another preferred embodiment of the invention, the control unit includes a computer program.

According to yet another preferred embodiment of the invention, the individual cogeneration plant can store unused power for future use.

According to yet another preferred embodiment of the invention, power is transferable between the individual cogeneration plant and the power grid, so that the unused power can be stored by the individual cogeneration plant for future use or transferred to the power grid.

According to yet another preferred embodiment of the invention, the control unit determines whether the unused power is stored by the individual cogeneration plant for future use or transferred to the power grid.

According to yet another preferred embodiment of the invention, a system for providing power includes a plurality of individual cogeneration plants. Each of the individual cogeneration plants provides power to a structure using an independent energy source. The individual cogeneration plants communicates with an external power grid, which is in communication with the structure so that power can be provided to the structure by the individual cogeneration plant and the external power grid. Each of a plurality of individual control units communicates with a respective individual cogeneration plant and maintains information relating to the operation of the respective individual cogeneration plant. A master control unit communicates with the external power grid and the plurality of individual control units so that information is exchanged between the master control unit and the plurality of individual control units. The master control unit determines an optimal setting of each of the individual cogeneration plants.

According to yet another preferred embodiment of the invention, the information received from the individual control units includes information such as atmospheric conditions, energy output capabilities and a desired price for energy transferred.

### BRIEF DESCRIPTION OF THE DRAWINGS

Some of the objects of the invention have been set forth above. Other objects and advantages of the invention will appear as the invention proceeds when taken in conjunction with the following drawings, in which:

FIG. 1 is a schematic view of an individual cogeneration plant according to a preferred embodiment of the invention;

FIG. 2 is a schematic view of an individual cogeneration plant according to another preferred embodiment of the invention;

FIG. 3 is a schematic view of an individual cogeneration plant according to yet another preferred embodiment of the invention;

FIG. 4 is a schematic view of an individual cogeneration plant according to yet another preferred embodiment of the invention; and

FIG. 5 is a schematic view of a system for providing power comprising a plurality of individual cogeneration plants according to a preferred embodiment of the invention.

### DESCRIPTION OF THE PREFERRED EMBODIMENT AND BEST MODE

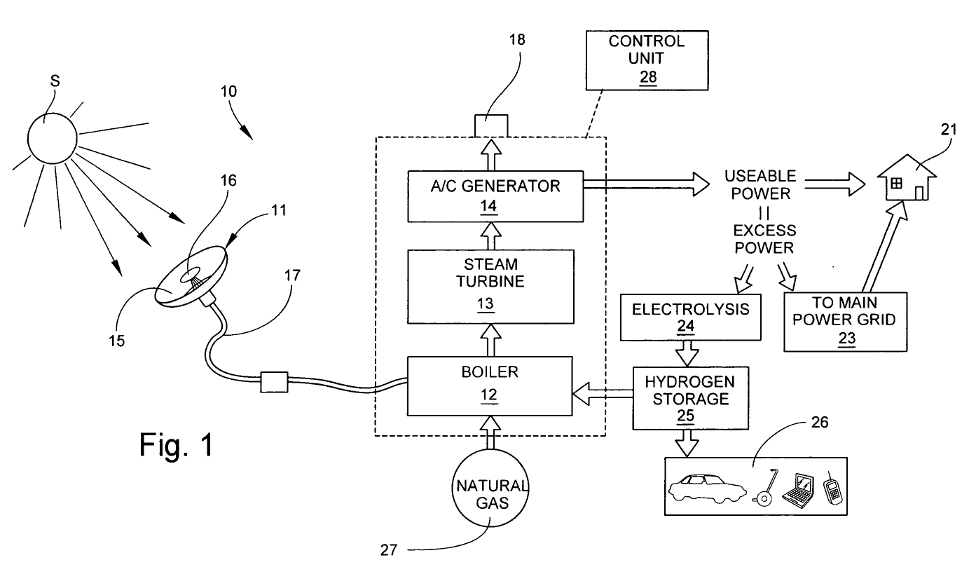

Referring now specifically to the drawings, a preferred embodiment of the individual cogeneration plant according to the present invention is illustrated in FIG. 1, and shown generally at reference numeral 10. The individual cogeneration plant 10 generally comprises a solar energy collector 11, a boiler 12, a steam turbine 13 and an electric generator 14.

The collector 11 comprises a dish 15, a focuser 16 positioned at the center of the dish 15, and a fiber optic cable 17 also positioned at the center of the dish 15 on the opposite side of the focuser 16. The fiber optic cable 17 connects the dish 15 to the boiler 12. The dish 15 and the focuser 16 direct solar radiation from the sun “S” into the fiber optic cable 17. The collected solar radiation travels through the fiber optic cable 17 to the boiler 12, which has a supply of water. The collected solar energy heats the boiler 12, which creates steam from the water that drives the steam turbine 13. The steam turbine 13 then drives the electric generator 14 to create useable power in the form of electricity that can be used in a structure 21. As used in this application, the term structure refers broadly to any kind of building, including a house, apartment or business. A steam discharge unit 18 allows for the escape of excess steam.

The useable power satisfies the typical power needs of the structure 21, such as electricity for lights, appliances, heating and air conditioning. If more power is generated than what is needed to satisfy the current power needs of the structure 21, the excess power can be either stored within the cogeneration plant 10 or transferred to an external main power grid 23. The main power grid 23 is a conventional power plant providing electricity to a plurality of structures across a large geographic area. If the excess power is to be stored, it is directed to an electrolysis device 24 where it is used to provide the necessary electricity for triggering electrolysis, which creates hydrogen gas from water. The hydrogen gas is then transferred to a hydrogen gas storage unit 25, where it can be stored until needed for a particular application. The stored hydrogen gas 25 can be used in place of solar energy, to generate heat for the boiler 12, and thereby power the cogeneration plant 10. Alternatively, the stored hydrogen gas 25 can be used to power hydrogen powered devices 26, such as automobiles, laptop computers, cell phones and Segueway vehicles.

Preferably, a natural gas reservoir 27 is connected to the boiler 12, and provides another alternative energy source for powering the cogeneration plant 10. The natural gas can be directed to the boiler 12 to generate heat creating steam for the steam turbine 13. Alternatively, the stored hydrogen gas can be fed into an existing pipeline that connects the structure 21 to a reservoir, such as the pipeline for the natural gas reservoir 27 if natural gas is no longer being used, or a new pipeline that connects the structure 21 to a reservoir, depending on the price of hydrogen gas and the preferences of the user. As such, hydrogen gas may come from a pipeline to feed the boiler, again depending on price and user preferences.

The structure 21 is preferably in communication with the main power grid 23 to provide yet another alternative energy source for the structure 21. As such, power can be supplied to the structure 21 by the main power grid 23, rather than the cogeneration plant 10.

Preferably, a control unit 28 processes relevant information to determine the optimum mode in which the cogeneration plant 10 should operate at any given time. The control unit 28 preferably comprises a computer program that considers factors such as atmospheric conditions (i.e. the amount of available sunlight), the amount of stored energy available, the cost of available natural gas, and the cost of electricity supplied by the main power grid 23 to determine whether the structure 21 is supplied power from the individual cogeneration plant 10 or the main power grid 23. If the structure 21 is supplied power from the individual cogeneration plant 10, then the control unit 28 determines whether the individual cogeneration plant 10 is powered by solar energy collected by the collector 11, stored hydrogen gas 25, or natural gas 27. In addition, if excess power is created by the cogeneration plant 10, then the control unit determines whether the excess power is directed to the electrolysis device 24 for storage as hydrogen gas, or transferred to the main power grid 23.

For example, if present atmospheric conditions are such that there is not enough sunlight to supply adequate solar energy to the collector 11, then the control unit 28 would opt for power to be supplied by another energy source. The control unit 28 could be programmed so that in this situation it would opt for the cogeneration plant 10 to use its reserve of stored hydrogen gas 25 until completely depleted or reaching a certain minimum level, at which time the cogeneration plant 10 would run on natural gas or the structure 21 would be powered by electricity supplied by the main power grid 23, depending on which was cheaper-natural gas or electricity from the power grid 23. Alternatively, the control unit 28 could be programmed such that natural gas or electricity from the power grid 23 would be utilized if the price for either was below a certain maximum price value, and if neither was below the maximum price, then the stored hydrogen gas 25 would be used to power the cogeneration plant 10.

In addition, the control unit 28 determines whether excess power is stored as hydrogen gas 25 or transferred to the main power grid 23. The control unit 28 could be programmed such that the excess power is stored as hydrogen gas unless the price paid by the main power grid 23 for the excess power is at or above a predetermined set minimum price. Alternatively, the control unit 28 could be programmed such that all excess power is directed to electrolysis 24 for storage as hydrogen gas until the hydrogen gas storage unit 25 is full, at which time any excess power is transferred to the main power grid 23. Of course, there are many other possibilities for programming the control unit 28 that would be apparent to those skilled in the art.

While the cogeneration plant 10 is preferably adapted for utilizing solar energy, the cogeneration plant 10 could be modified to utilize other renewable energy sources such as wind as would be apparent to those skilled in the art. Such a modification would require using a collector adapted for collecting and transferring wind energy.

The individual cogeneration plant 10 gives a homeowner the choice of how to power his or her home, depending on current utility prices and other factors. The homeowner can power his home by sunlight when available, by stored hydrogen gas, by natural gas or by the main power grid 23. The chart below illustrates the homeowner's power options with the cogeneration plant 10.

| | | Extra Power |
|---|---|---|
| Home Power Primary | Home Power | Created by |
| Source | Secondary Source | Cogeneration Plant |
| Individual cogeneration | Main Power Grid | Back-Feed Main |
| plant fed by Sunlight | | Power Grid |
| Individual cogeneration | Main Power Grid | Create and Store |
| plant fed by Sunlight | | Hydrogen |
| | | from Water |
| Individual cogeneration | Main Power Grid | |
| plant fed by Hydrogen | | |
| Individual cogeneration | Main Power Grid | |
| plant fed by Natural Gas | | |
| Main Power Grid | Individual cogeneration | Back-Feed Main |
| | plant fed by Sunlight | Power Grid |
| Main Power Grid | Individual cogeneration | Create and Store |
| | plant fed by Sunlight | Hydrogen |
| | | from Water |

As shown in the above chart, the cogeneration plant 10 can be the primary or secondary source of power for the homeowner. As the primary source of power, the individual cogeneration plant 10 would use sunlight, hydrogen or natural gas to fire the boiler 12. This option gives the homeowner the ability to choose his or her power source depending on current utility prices. This also gives the homeowner the ability to run “off-grid” in the case of power outages due to weather or other factors. The cogeneration plant 10 reduces the homeowners utility bills, feeds electricity back into the main power grid 23, provides the homeowner with a backup source of power in the event of a power failure, and creates hydrogen from water.

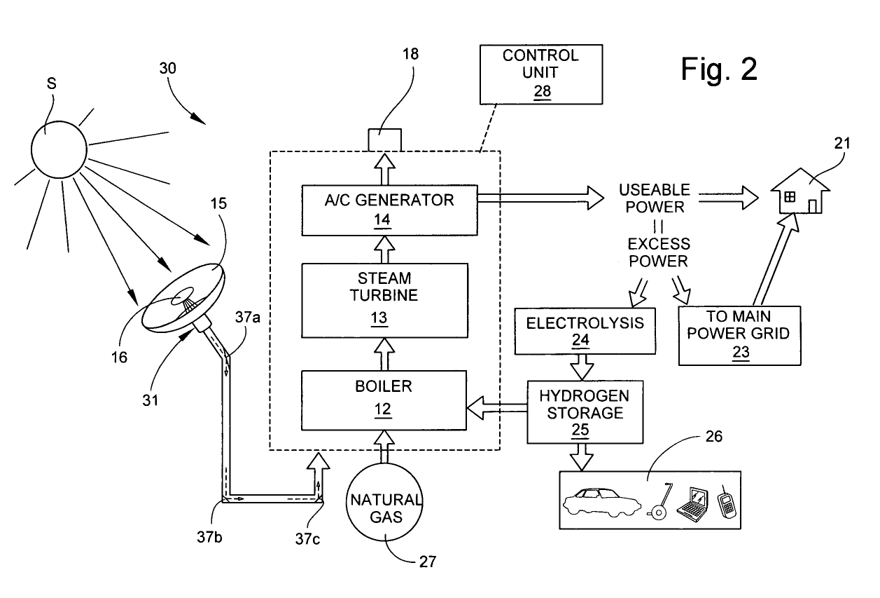

Another preferred embodiment of the invention is illustrated in FIG. 2, and shown generally at reference numeral 30. The individual cogeneration plant 30 is identical to the previously described cogeneration plant 10, except that it includes a collector 31 having a series of mirrors 37a, 37b, 37c instead of a fiber optic cable. The mirrors 37a, 37b, 37c are positioned to direct the solar radiation collected by the dish 15 and focuser 16 to the boiler 12 to heat the boiler 12. The individual cogeneration plant 30 is identical to the above described cogeneration plant 10 in all other respects, and therefore all other features are denoted with identical reference numerals and are not discussed in further detail here.

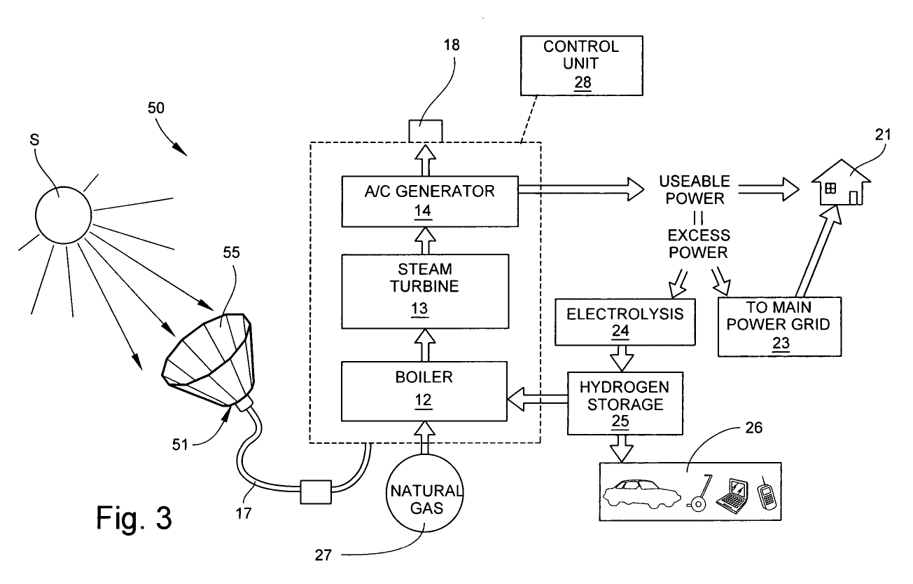

Yet another preferred embodiment of the invention is illustrated in FIG. 3, and shown generally at reference numeral 50. The individual cogeneration plant 50 is identical to previously described cogeneration plant 10, except that it includes a collector 51 comprising a fresnel lense 55 for collecting solar radiation. The fiber optic cable 17 connects the fresnel lense 55 to the boiler 12. The collected solar radiation travels through the fiber optic cable 17 to the boiler 12, and heats the boiler 12. The individual cogeneration plant 50 is identical to the above described cogeneration plant 10 in all other respects, and therefore all other features are denoted with identical reference numerals and are not discussed in further detail here.

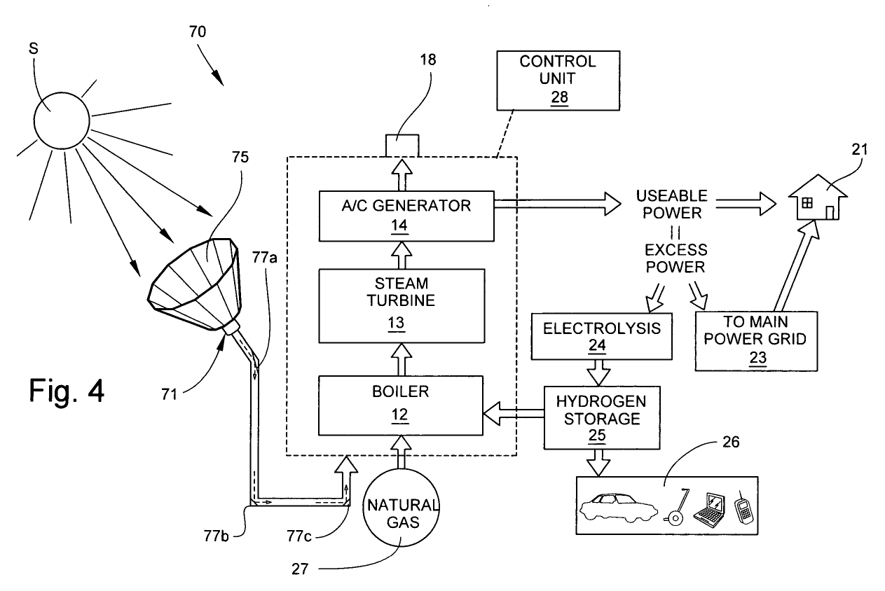

Yet another preferred embodiment of the invention is illustrated in FIG. 4, and shown generally at reference numeral 70. The individual cogeneration plant 70 is identical to previously described cogeneration plant 10, except that it includes a collector 71 having a fresnel lense 75 and a series of mirrors 77a, 77b, 77c. The mirrors 77a, 77b, 77c are positioned to direct the solar radiation collected by the fresnel lense 75 to the boiler 12 to heat the boiler 12. The individual cogeneration plant 70 is identical to the above described cogeneration plant 10 in all other respects, and therefore all other features are denoted with identical reference numerals and are not discussed in further detail here.

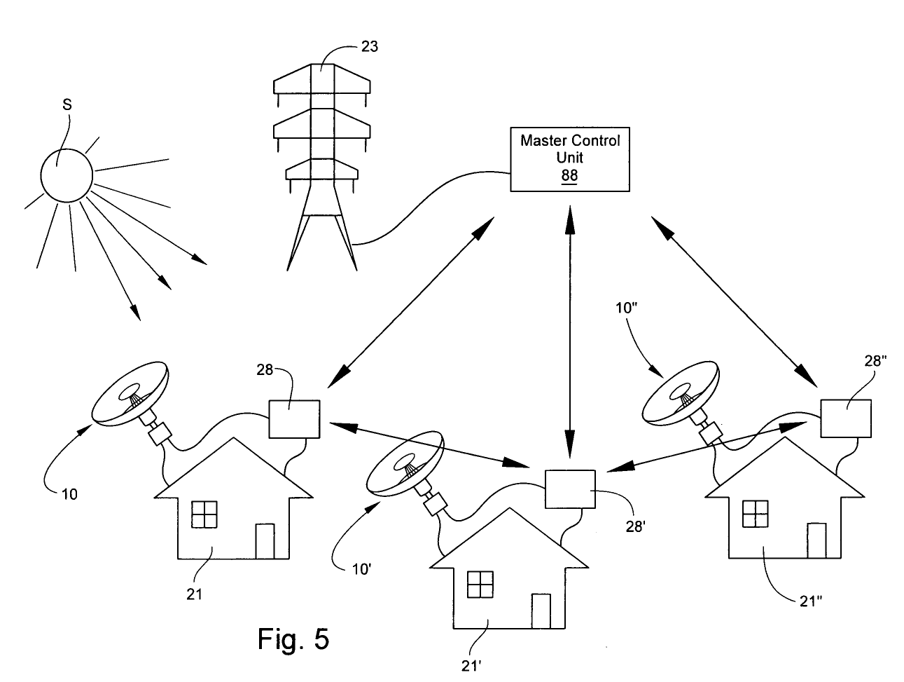

In yet another preferred embodiment of the invention, a plurality of individual cogeneration plants 10, 10′, 10″ are provided, with each individual cogeneration plant 10, 10′, 10′ operatively connected to supply power to a structure 21, 21′, 21″, respectively, and to each other, as shown in FIG. 5. Each cogeneration plant 10, 10′, 10″ is linked to an individual control unit 28, 28′, 28″, respectively. The individual control units 28, 28′, 28″ communicate with each other and a master control unit 88, which is linked to the main power grid 23. The power grid 23 can provide power to each structure 21, 21′, 21″, and can receive power from each cogeneration plant 10, 10′, 10″. The master control unit 88 collects and stores data relating to the main power grid 23, such as the price that is currently being charged by the main power grid 23 for supplying power, the price currently being paid for power supplied to the power grid 23, and the current power supply and capabilities of the power grid 23. Likewise, each of the individual control units 28, 28′, 28″ collects and stores information relating to its respective individual cogeneration plant 10, 10′, 10″, such as atmospheric conditions, the current available power output of the respective individual cogeneration plant, the amount of stored hydrogen gas, the amount of natural gas available to the respective individual cogeneration plant, and the current power requirements of the particular structure.

The individual control units 28, 28′, 28″ communicate to the master control unit 88 and with each other the current power requirements and capabilities of each respective individual cogeneration plant 10, 10′, 10″, as well as the other related information described above for each individual cogeneration plant 10, 10′, 10″. The master control unit 88 processes the information transmitted to it by the individual control units 28, 28′, 28″ and the information it maintains relating to the main power grid 23, and makes a determination as to the most efficient way to power the structures 21, 21′, 21″. For example, if the information transmitted to the master control unit 88 indicates that due to atmospheric conditions a particular individual cogeneration plant 10 is generating excess power, while another individual cogeneration plant 10′ does not currently have sufficient power to power its respective structure 21′, the master control unit 88 can either direct the first cogeneration plant 10 to transfer its excess power to the second cogeneration plant 10″ or transfer the needed power from the power grid 23 to the second cogeneration plant 10″. The determination as to whether needed power is supplied by the power grid 23 or another cogeneration plant can be based on the respective cost for each power source.

The control units 28, 28′, 28″ transmit to the master control unit 88 a set minimum price at which each cogeneration plant 10, 10′, 10″ will sell its excess power to the power grid 23 and the other cogeneration plants 10, 10′, 10″. The master control unit 88 compares these prices and the price of power from the power grid 23 to determine the most cost effective means for powering the structures 21, 21′, 21″. If the cost of power from an individual cogeneration plant 10 is lower than from the power grid 23, the master control unit 88 directs the first cogeneration plant 10 to transfer its excess power to the second cogeneration plant 10′. If the cost of power from the first cogeneration plant 10 is higher than the price of power from the power grid 23, then the master control unit 88 directs the power grid 23 to supply the second cogeneration plant 10′ with its needed power.

Other factors can be considered by the master control unit 88, such as the cost and availability of natural gas, and the availability of stored hydrogen gas for each individual cogeneration plant 10, 10′, 10″. The master control unit 88 can be programmed so that at times when solar energy is not available, each individual cogeneration plant 10, 10″, 10″ uses its supply of stored hydrogen gas if the price of power supplied from other cogeneration plants or the power grid 23, or available natural gas, exceeds a predetermined maximum price.

Alternatively, each individual control unit 28, 28′, 28″ has the power to make the ultimate decision as to how its respective individual cogeneration plant 10, 10′, 10″ operates and provides power to its respective structure 21, 21′, 21″ at any given time. Each individual control unit 28, 28′, 28″ is programmed to communicate a minimum selling price for the excess power of its respective individual cogeneration plant 10, 10′, 10″, and a maximum purchasing price at which the individual control unit 28, 28′, 28″ will purchase excess power from the other cogeneration plants 10, 10′, 10″ or the main power grid 23. This information is communicated to the master control unit 88 and the other individual control units 28, 28′, 28″, either directly or through the master control unit 88. Likewise, the master control unit 88 communicates to the individual control units 28, 28′, 28″ a minimum selling price for power from the main power grid 23, and a maximum purchasing price at which the main power grid 23 will purchase excess power from the cogeneration plants 10, 10′, 10″. Each individual control unit 28, 28′, 28″ processes this information, along with other relevant factors such as current atmospheric conditions, and the current availability of natural gas and stored hydrogen gas for its respective individual cogeneration plant 10, 10′, 10″, to determine an optimum setting for the respective individual cogeneration plant 10, 10′, 10″ to provide needed power to its respective structure 21, 21′, 21″.

For example, the user of one individual cogeneration plant 10 may decide that he will pay no more than $0.08 per kilowatt hour for power from external sources, and programs his respective individual control unit 28 accordingly. Current atmospheric conditions are such that there is not enough solar energy available for the cogeneration plant 10 to adequately meet the power demands of its respective structure 21. Meanwhile, the individual control unit 28′ for another individual cogeneration plant 10′ communicates that it will sell its excess power for $0.06 per kilowatt hour, and the individual control unit 28″ for yet another individual cogeneration plant 10″ communicates that it will sell excess power for $0.07. In addition, the master control unit 88 communicates that the power grid 23 will sell power for $0.09 per kilowatt hour, and the price of available natural gas is $0.08. Under these conditions, the individual control unit 28 would determine that in order to meet the power demands of its respective structure 21, power will first be imported from the second cogeneration plant 10′ at a rate of $0.06 per kilowatt hour, and if additional power is needed, then excess power from the third cogeneration plant 10″ is imported at the price of $0.07. If the excess power available from the other cogeneration plants 10′, 10″ does not completely satisfy the power demands of the structure 21, then natural gas is used at a rate of $0.08 per kilowatt hour. If all available natural gas is utilized, the cogeneration plant 10 will not import power from the main power grid 23 since its price of $0.09 per kilowatt hour exceeds the maximum price set by the individual control unit 28. Instead, the cogeneration plant 10 will utilize its reserve of stored hydrogen gas. In addition, under this scenario, the master control unit 88 may decide to purchase excess power from the second and third cogeneration plants 10′, 10″ at rates of $0.06 and $0.07 per kilowatt hour, respectively, if the power can then be resold by the main power grid 23 at a rate of $0.09 per kilowatt hour.

While FIG. 5 illustrates a system utilizing three individual cogeneration plants 10, 10′, 10″, there is no limit to the number of cogeneration plants that can be connected in a single system. If a large number of homeowners had individual cogeneration plants, they could serve as a distributed source of power that back-feeds the main power grid in the event of local or national emergencies such as grid-failure, terrorist attack or bad weather. Power plants and power equipment would be less-likely terrorist targets due to the fact that the individual cogeneration plants could provide power in the event of a disruption in service of the main power grid. The invention may also eliminate the need to upgrade the national power-grid as cities could operate without power from the national grid if enough individual cogeneration plants were utilized to provide a sufficient supply of power. As such, a city could be it's own power source. In the event that the load increased on the national grid, a message could be sent to the individual cogeneration plants in the affected area and they could ramp up power production. The invention enables individuals to participate in the wholesale power market.

An individual cogeneration plant and methods of using same are disclosed above. Various embodiments of the invention can be made without departing from its scope. Furthermore, the foregoing description of the preferred embodiment of the invention and the best mode for practicing the invention are provided for the purpose of illustration only and not for the purpose of limitation- the invention being defined by the claims.

1. A system for providing power comprising:
(a) a collector for collecting solar energy and transmitting heat generated from the solar energy;
(b) a boiler in direct communication with the collector for receiving the heat transmitted from the collector and generating steam from water using the heat transmitted from the collector, and wherein the boiler is powerable by solar energy, hydrogen and natural gas;
(c) a generator in communication with the boiler for generating electricity from the steam generated by the boiler; and
(d) means for transforming unused electricity generated by the system into storable energy for future use, whereby unused electricity can be stored in the system or transferred out of the system.

2. A system for providing power according to claim 1, wherein the unused electricity transferred out of the system is sold to a main power grid.

3. A system for providing power according to claim 1, wherein the collector comprises a solar dish and a focuser for collecting the solar energy.

4. A system for providing power according to claim 3 wherein the collector comprises a fiber optic cable for transmitting the heat generated by the solar energy.

5. A system for providing power according to claim 3, wherein the collector comprises a plurality of mirrors for transmitting the heat generated by the solar energy.

6. A system for providing power according to claim 1, wherein the collector comprises a fresnel lens for collecting the solar energy.

7. A system for providing power according to claim 6, wherein the collector comprises a fiber optic cable for transmitting the heat generated by the solar energy.

8. A system for providing power according to claim 6, wherein the collector comprises a plurality of mirrors for transmitting the heat generated by the solar energy.

9. A system for providing power according to claim 1, wherein the boiler is in communication with electricity stored in the system, whereby the boiler can generate steam from water using the electricity stored in the system.

10. A system for providing power according to claim 1, wherein the boiler includes burners for receiving heat to convert the water to steam.

11. A system for providing power according to claim 1, wherein the generator comprises a steam turbine and an electrical generator, wherein the steam turbine drives the electrical generator.

12. A system for providing power according to claim 1, wherein unused electricity stored in the system Is stored as hydrogen gas.

13. A system for providing power according to claim 12, wherein the system is adapted for providing power to a structure, and stored hydrogen gas is transferred to a reservoir connected to the structure by a pipeline.

14. A system for providing power according to claim 12, further comprising means for generating hydrogen gas from water, whereby unused electricity powers the generation of the hydrogen gas from water and the hydrogen gas is stored for future use as energy.

15. A system for providing power according to claim 1, further comprising a control unit, whereby a user can control whether unused electricity is stored in the system or transferred out of the system based on current market prices.

16. A system for providing power according to claim 1, further comprising a positioning device for positioning the collector in a position suitable for receiving solar energy.

17. A system for providing power according to claim 1, wherein the system supplies power to a structure, and further wherein the system is connected to a power grid supplying power to a plurality of structures, and power transferred out of the system is transferred to the power grid.

18. A system for providing power according to claim 1, wherein the system is connected to an alternative energy source selected from the group consisting of natural gas and methane, whereby be said alternative energy source supplied to the system when solar energy is unavailable.

19. A system for providing power according to claim 18, wherein the alternative energy source is connected to the boiler.

20. A system for providing power according to claim 1, wherein the system is powerable by an energy source selected from the group consisting of solar energy, stored hydrogen gas, natural gas and electricity provided by an external power grid.

21. A system for providing power according to claim 20, further comprising a control unit for selecting the energy source for powering the structure based on one or more predetermined factors.

22. A system for providing power according to claim 21, wherein the predetermined factors are selected from the group consisting of atmospheric conditions, cost of the electricity from the external power grid, cost of the natural gas, price paid for power transferred to the external power grid, and price paid for the stored hydrogen gas.

23. A system for providing power according to claim 1, further comprising a control unit for determining whether unused electricity will be stored as hydrogen gas or transferred out of the system based on one or more predetermined factors,

24. A system for providing power according to claim 23, wherein the predetermined factors are selected from the group consisting of atmospheric conditions, cost of the electricity from the external power grid, cost of the natural gas, price paid for power transferred to the external power grid, and price paid for the stored hydrogen gas.

25. (canceled)

26. (canceled)

27. (canceled)

28. A system for providing power according to claim 1, wherein the system is adapted for providing power to a structure, and further comprising a control unit in communication with an external power grid, wherein the control unit determines whether the structure is powered by the system or by the power grid.

29. A system for providing power according to claim 28, wherein the control unit comprises a computer program.

30. A system for providing power according to claim 28, wherein the predetermined factors are selected from the group consisting of atmospheric conditions, cost of the electricity from the external power grid, cost of the natural gas, price paid for power transferred to the power grid, and price paid for stored hydrogen gas.

31. (canceled)

32. A system for providing power according to claim 28, wherein power is transferable between the system and the power grid, whereby the unused power can be stored by the system for future use or transferred to the power grid.

33. A system for providing power according to claim 32, wherein the control unit determines whether the unused power is stored by the system for future use or transferred to the power grid.

34. A system for providing power comprising:
(a) a plurality of individual cogeneration plants, each of the individual cogeneration plants adapted for providing power to a structure using an independent energy source, the individual cogeneration plants in communication with an external power grid in communication with the structure whereby power can be provided to the structure by at least one of the individual cogeneration plants and the external power grid, and wherein at least one of the cogeneration plants comprises:
(i) a collector for collecting solar energy and transmitting heat generated from the solar energy,
(ii) a boiler in direct communication with the collector for receiving the heat transmitted from the collector and generating steam from water using the heat transmitted from the collector,
(iii) a generator in communication with the boiler for generating electricity from the steam generated by the boiler, and
(iv) means for transforming unused electricity generated by the system into storable energy for future use, whereby unused electricity can be stored in the cogeneration plant or transferred to the external power grid;
(b) a plurality of individual control units, each of the individual control units in communication with a respective individual cogeneration plant and maintaining information relating to the operation of the respective individual cogeneration plant; and
(c) a master control unit communicating with the external power grid and the plurality of individual control units, whereby information is exchanged between the master control unit and the plurality of individual control units, and each of the individual control units determines an optimal setting for respective individual cogeneration plant based on the information exchanged.

35. A system according to claim 34, wherein the information received from the individual control units includes one or more selected from the group consisting of atmospheric conditions, energy output capabilities and a desired price for energy transferred.

36. A system for providing power comprising:
(a) a plurality of individual cogeneration plants adapted for providing power to a plurality of residential structures using an independent energy source, the individual cogeneration plants in communication on with a main power supplier in communication with the structures whereby power can be provided to each of the structures by one of the individual cogeneration plants and the main power supplier;
(b) a plurality of individual control units, each of the individual control units in communication with a respective individual cogeneration plant and maintaining information relating to the operation of the respective individual cogeneration plant; and
(c) a master control unit communicating with the external power grid and the plurality of individual control units, whereby information is exchanged by the master control unit and the plurality of individual control units and each of the individual control units determines whether one of the structures Is powered by one of the individual cogeneration plants or the main power supplier based on the information exchanged.

37. A system for providing power according to claim 36, wherein each of the individual control units communicates to the master control unit and the other individual control units a minimum price at which excess power of the respective individual cogeneration plant will be sold and a maximum price at which power from the main power supplier and the other individual cogeneration plants will be purchased.

38. A system for providing power according to claim 37, wherein the master control unit communicates to the individual control units a minimum price at which the main power supplier will sell power to the residential structures and a maximum price the external main power supplier will pay for power from the individual cogeneration plants.

39. A system for providing power according to claim 1, further comprising a plurality of burners for providing heat to the boiler, wherein the burners are powerable by solar energy, hydrogen and natural gas.
